(19) United States
(12) Patent Application Publication
(10) Pub. No.: US 2022/0224157 A1
(43) Pub. Date: Jul. 14, 2022

(54) WIRELESS CHARGING OF ELECTRONIC DEVICES

(71) Applicant: Hewlett-Packard Development Company, L.P., Spring, TX (US)

(72) Inventors: Yi-Kang Hsieh, Taipei City (TW); Chung-Chun Chen, Taipei City (TW); Ming-Shien Tsai, Taipei City (TW); Han-Kuang Chang, Taipei City (TW); Isaac Lagnado, Spring, TX (US)

(21) Appl. No.: 17/708,365

(22) Filed: Mar. 30, 2022

Related U.S. Application Data
(63) Continuation of application No. 16/490,663, filed on Sep. 3, 2019, now abandoned.

(51) Int. Cl. H02J 50/10; H04B 5/00; H04B 1/3827; H02J 50/40; H02J 50/80

(52) U.S. Cl. CPC H02J 50/10; H04B 5/0081; H02J 50/80; H04B 1/3827; H02J 50/40; H04B 5/0037

(57) ABSTRACT

Wireless charging of electronic devices is described. In an example implementation, electromagnetic current is induced in a first set of coils of an electronic device upon coupling of the first set of coils with a second set of coils of a charging base, and a rechargeable battery of the electronic device is wirelessly charged based on the induced electromagnetic current. A coil from amongst the first set is determined to send a message to the charging base to disable a coil of the second set which overlaps with the determined coil of the first set.

### PRIORITY INFORMATION

This application is a continuation of U.S. application Ser. No. 16/490,663 filed on Sep. 3, 2019, which claims priority to International Application No. PCT/US2017/021280 filed on Mar. 8, 2017. The contents of which are incorporated herein by reference in its entirety.

### BACKGROUND

Electronic devices, such as laptops, tablets, and smartphones, are used by users for various purposes. Such electronic devices are portable and include a rechargeable battery for powering the electronic device. The rechargeable battery of the electronic devices may be charged wirelessly through electromagnetic induction.

### BRIEF DESCRIPTION OF DRAWINGS

The following detailed description references the drawings, wherein:

FIG. 1 illustrates a block diagram of an electronic device and a charging base for wireless charging, according to an example of the present subject matter;

FIG. 2 illustrates a block diagram of an electronic device and a charging base for wireless charging, according to an example of the present subject matter;

FIG. 3 illustrates a method of wireless charging a rechargeable battery in an electronic device, according to an example of the present subject matter;

FIG. 4 illustrates a method of wireless charging a rechargeable battery in an electronic device, according to an example of the present subject matter;

FIG. 5 illustrates a method of wireless charging a rechargeable battery in an electronic device, according to an example of the present subject matter; and

FIG. 6 illustrates a system environment implementing a non-transitory computer readable medium for wireless charging, according to an example of the present subject matter.

### DETAILED DESCRIPTION

Electronic devices may include an inductive coil to enable wireless charging. The inductive coil of an electronic device, simply referred to as the coil, may electromagnetically couple with a coil of a charging base, when the electronic device is placed on the charging base. The coil of the charging base may operate as a primary coil and the coil of the electronic device may operate as a secondary coil for electromagnetic induction. The electromagnetic coupling of such coils induces electromagnetic current in the coil of the electronic device. Electromagnetic current induced in the coil can be provided to charge a rechargeable battery of the electronic device.

Electronic devices may also include a transceiver for providing near-field communication (NFC) with other devices. The coils in the charging base and in the electronic device for wireless charging may be so arranged such that electromagnetic interactions between the coils may interfere with the NFC. As a result, the quality of NFC may be adversely affected during wireless charging.

Electronic devices may also include a touch-pad as an input unit through which touch-based user inputs can be received. The arrangement of coils in the charging base and in the electronic device may be such that electromagnetic interactions between the coils may interfere with functioning of the touch-pad. As a result, the performance of the touch-pad may be adversely affected during wireless charging.

Further, a specific region in the electronic device, for example, in the vicinity of the battery of the electronic device or in the vicinity of a processor, may heat up during the operation of the electronic device. The arrangement of coils in the charging base and in the electronic device may be such that electromagnetic interactions between the coils may contribute to heating and thus may overheat that specific region.

The present subject matter describes approaches for wireless charging of electronic devices using a charging base. According to an example implementation of the present subject matter, the electronic device includes a first set of coils, and the charging base includes a second set of coils. The first set of coils and the second set of coils may overlap when the electronic device is placed over the charging base. The approaches of the present subject matter involve at least disabling, or switching OFF, a coil in the charging base that may overlap a coil in the electronic device present in a region of NFC, or in a region of touch-pad, or in a region of high temperature in the electronic device, while continuing to wirelessly charge the electronic device through other coils of the charging base. The approaches of the present subject matter facilitate wireless charging of the electronic device without affecting the NFC and the touch-pad functionality, and without overheating of the region of high temperature.

In an example implementation, a coil of the first set that is present in a region of NFC in the electronic device may be determined. Accordingly, a message may be sent from the electronic device to the charging base to disable a corresponding coil of the second set which overlaps with the determined coil of the first set. With this, the coil of the charging base which may otherwise interfere with the NFC is disabled, while the wireless charging of the electronic device continues through other coils of the first set and the second set.

In an example implementation, a coil of the first set that is present under the touch-pad of the electronic device may be determined. Accordingly, a message may be sent from the electronic device to the charging base to disable a corresponding coil of the second set which overlaps with the determined coil of the first set. With this, the coil of the charging base which may otherwise interfere with the touch-pad functionality is disabled, while the wireless charging of the electronic device continues through other coils of the first set and the second set.

In an example implementation, a coil of the first set that is present in a region at a temperature more than a specific temperature may be determined. Accordingly, a message may be sent from the electronic device to the charging base to disable a corresponding coil of the second set which overlaps with the determined coil of the first set. With this, the coil of the charging base which may otherwise cause overheating of the specific region in the electronic device is disabled, while the wireless charging of the electronic device continues through other coils of the first set and the second set.

Selective disabling of one or more coils of the charging base, according to the present subject matter, facilitates wireless charging of the electronic device through other coils of the charging base without impacting other operations of the electronic device.

The present subject matter is further described with reference to the accompanying figures. Wherever possible, the same reference numerals are used in the figures and the following description to refer to the same or similar parts. It should be noted that the description and figures merely illustrate principles of the present subject matter. It is thus understood that various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

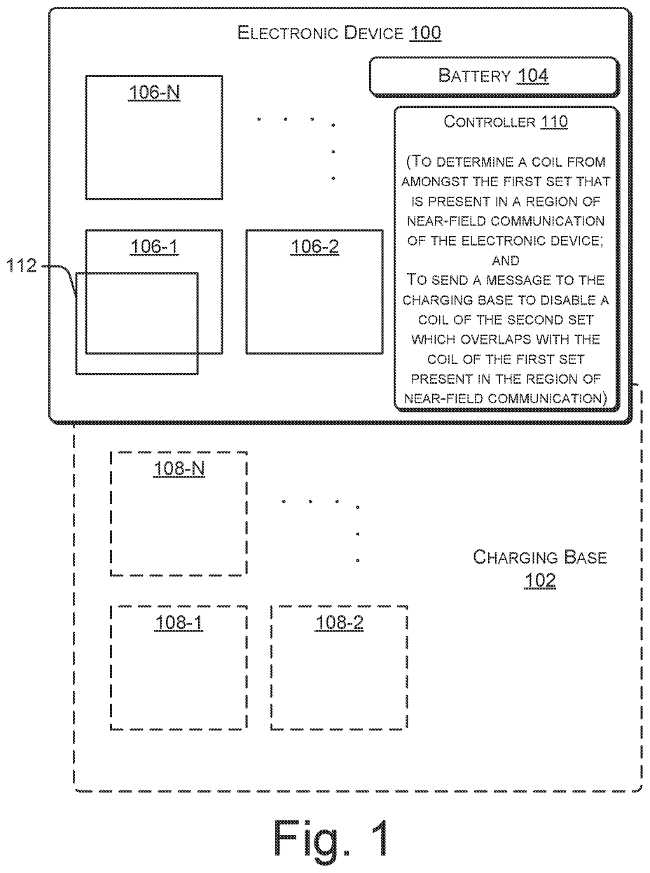

FIG. 1 illustrates a block diagram of an electronic device 100 and a charging base 102 for wireless charging, according to an example of the present subject matter. The electronic device 100 may be placed on the charging base 102 for the purpose of wireless charging of the electronic device 100. The electronic device 100 may include, but is not restricted to, laptops, smartphones, tablets, and the like.

The electronic device 100, as shown, includes a battery 104 and a first set of coils 106-1, 106-2, . . . , 106-N. The battery 104, for example, is a rechargeable battery. The first set of coils, collectively be referred to as device coils 106, may be communicatively coupled to the battery 104. Each of the device coils 106 is individually coupled to the battery 104. Each of the device coils 106 may provide current, which may be induced or generated in the respective device coils 106, to the battery 104 for charging the battery 104.

As shown, the charging base 102 includes a second set of coils 108-1, 108-2, . . . , 108-N, collectively referred to as charging coils 108. When the electronic device 100 is placed on the charging base 102 and current is passed through the charging coils 108, the charging coils 108 electromagnetically couple with the device coils 106 of the electronic device 100. The electromagnetic coupling induces or generates electromagnetic current in the device coils 106.

In an example implementation, the number, the size and the arrangement of device coils 106 in the electronic device 100 are the same as the number, the size and the arrangement of charging coils 108 in the charging base 102. The size and the arrangement are such that each coil of the device coils 106 has one-to-one correspondence with a coil of the charging coils 108. Thus, when the electronic device 100 is placed on the charging base 102, each coil of the device coils 106 overlaps a corresponding coil of the charging coils 108. With reference to FIG. 1, the coil 106-1 overlaps the coil 108-1, the coil 106-2 overlaps the coil 108-2, and so on, when the electronic device 100 is placed on the charging base 102. With the overlapping arrangement of coils, each pair of overlapping coils 106-1 and 108-1, 106-2 and 108-2, . . . , can individually couple electromagnetically for charging the battery 104.

The arrangement of device coils 106 and charging coils 108 is not restricted to the example arrangement shown in FIG. 1. Coils can be placed in the electronic device 100 any form of arrangement to facilitate wireless charging of the battery of the electronic device 100. Coils are placed in the charging base 102 in the same arrangement as those present in the electronic device 100.

The device coils 106 and the charging coils 108, respectively, may include two or more coils. In an example implementation, the electronic device 100 and the charging base 102, respectively, include two coils of 20 W each. In an example implementation, the electronic device 100 and the charging base 102, respectively, include four coils of 10 W each. With four coils, the arrangement of coils may be like a 2×2 grid arrangement.

The electronic device 100 further includes a controller 110. The controller 110 can be implemented through a combination of any suitable hardware and computer-readable instructions. The controller 110 may be implemented in a number of different ways to perform various functions for the purposes of wireless charging of the electronic device 100. For example, the computer-readable instructions for the controller 110 may be processor-executable instructions stored in a non-transitory computer-readable storage medium, and the hardware for the controller 110 may include a processing resource (e.g., processor(s)), to execute such instructions. In the present examples, the non-transitory computer-readable storage medium stores instructions which, when executed by the processing resource, implements the controller 110. The electronic device 100 may include the non-transitory computer-readable storage medium storing the instructions and the processing resource (not shown) to execute the instructions. In an example, the non-transitory computer-readable storage medium storing the instructions may be external, but accessible to the processing resource of the electronic device 100. In another example, the controller 110 may be implemented by electronic circuitry.

The processing resource of the electronic device 100 may be implemented as microprocessors, microcomputers, microcontrollers, digital signal processors, central processing units, state machines, logic circuitries, and/or any devices that manipulate signals based on operational instructions. Among other capabilities, the processing resource may fetch and execute computer-readable instructions stored in a non-transitory computer-readable storage medium coupled to the processing resource of the electronic device 100. The non-transitory computer-readable storage medium may include, for example, volatile memory (e.g., RAM), and/or non-volatile memory (e.g., EPROM, flash memory. NVRAM, memristor, etc.).

In an example implementation, the electronic device 100 may include a transceiver (not shown) for performing near-field communication (NFC) between the electronic device 100 and other devices placed in the vicinity. The transceiver may be positioned in the electronic device 100 to perform the NFC through a region 112 of the electronic device 100. The region 112 may be referred to as the region of NFC. The region of NFC 112 defines a physical space of the electronic device 100 which may enclose circuitry for NFC and through which signals associated with the NFC are transmitted and received by the transceiver.

The description hereinafter describes a procedure of wireless charging of the electronic device 100 using the charging base 102, in accordance with an example implementation. For the purpose of wireless charging of the electronic device 100, the electronic device 100 is placed on the charging base 102 such that the device coils 106 overlap the charging coils 108. Upon switching ON the charging base 102, current is passed through each of the charging coils 108. The current in the charging coils 108 generates electromagnetic field. The electromagnetic field from the charging coils 108 causes electromagnetic coupling of the charging coils 108 with the device coils 106 to induce electromagnetic current in the device coils 106. The controller 110 directs the induced electromagnetic current from the device coils 106 to the battery 104 for charging the battery 104. In an example implementation, the controller 110 may be initially powered by the electromagnetic current induced in the device coils 106, when the battery 104 is fully depleted. Otherwise the controller 110 may be powered by the battery 104.

In an example implementation, the controller 110 determines a coil, from amongst the device coils 106, that is present in the region of NFC 112. The controller 110 may determine the coil that is present in the region of NFC 112 based on the information of placement of device coils 106. For this, in an example implementation, information with regard to which coil is placed in the region of NFC 112 is stored in a memory (not shown) of the electronic device 100. The information may be stored at the time of assembling or configuring the electronic device 100. The information may include an attribute of the coil, for example, the coil number, which is present in the region of NFC 112. The controller 110 may fetch such information stored in the electronic device 100 to determine the coil that is present in the region of NFC 112.

Upon determining the coil that is present in the region of NFC 112, the controller 110 sends a message to the charging base 102, where the message is indicative of disabling a coil, from amongst the charging coils 108, which overlaps with the determined coil. Such a message may be referred to as a coil-OFF message which may include information indicative of a coil to be disabled. In an example implementation, the charging base 102 receives the coil-OFF message and accordingly disables the coil from amongst the charging coils 108 as indicated by the coil-OFF message. To disable a coil of the charging base 102, the current supply to the coil may be cut-off so that no electromagnetic current is induced or generated in a corresponding coil of the electronic device 100.

With reference to FIG. 1, the controller 110 determines the coil 106-1 to be present in the region of NFC 112, and sends a message to disable the coil 108-1. Once the coil 108-1 is disabled, the battery 104 is charged through other coils of the charging base 102 and the electronic device 100 without affecting the NFC that may be performed with the electronic device 100.

In an example implementation, the controller 110 determines, in real-time, whether the transceiver is active for the NFC. When the transceiver is determined to be active, the controller 110 sends the message to the charging base 102 to disable the coil of the charging base 102 which overlaps with the coil of the electronic device 100 present in the region of NFC 112. Further, when the transceiver is determined to be inactive, the controller 110 sends a message to the charging base, which indicates to enable the coil of charging base 102 which overlaps with the coil of the electronic device 100 present in the region of NFC 112. Such a message may be referred to as a coil-ON message. In an example implementation, the charging base 102 receives the coil-ON message and accordingly enables the coil of the charging base 102 as indicated by the coil-ON message. To enable a coil of the charging base 102, the current supply to the coil may be switched ON so that electromagnetic current is induced or generated in a corresponding coil of the electronic device 100. Disabling and enabling the coil of charging base 102 in real-time depending on whether the transceiver is active or inactive facilitates in efficient and effective wireless charging of the electronic device 100 without affecting the NFC.

In an example implementation, charging base 102 also include a controller (not shown). The controller of the charging base 102 can be implemented through a combination of any suitable hardware and computer-readable instructions, in a similar manner as that for the controller 110, to perform various functions for the purposes of wireless charging of the electronic device 100. For example, the computer-readable instructions for the controller of the charging base 102 may be processor-executable instructions stored in a non-transitory computer-readable storage medium, and the hardware for the controller of the charging base 102 may include a processing resource (e.g., processor(s)), to execute such instructions. The charging base 102 may include the non-transitory computer-readable storage medium storing the instructions and the processing resource (not shown) to execute the instructions. In another example, the controller of the charging base 102 may be implemented by electronic circuitry. The non-transitory computer-readable storage medium and the processing resource of charging base 102, respectively, may be similar to that of the electronic device 100.

In an example implementation, the controller of the charging base 102 may switch ON or OFF the flow of current through the charging coils 108 of the charging base 102. The controller of the charging base 102 may receive the message and accordingly disable or enable a coil from amongst the charging coils 108 of the charging base 102.

In an example implementation, the electronic device 100 and the charging base 102 may communicate with each other to send and receive the messages over a wired communication link or a wireless communication link. The electronic device 100 and the charging base 102 may include interfaces (not shown) for the purpose of sending and receiving such messages. In an example implementation, the interfaces may include Bluetooth™ transmitters and receivers, Universal Serial Bus (USB) ports, and the like.

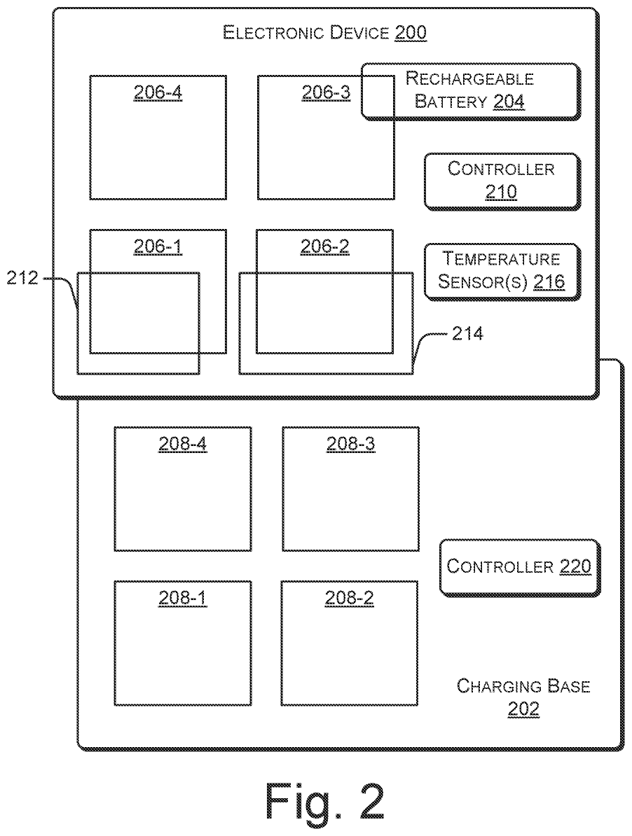

FIG. 2 illustrates a block diagram of an electronic device 200 and a charging base 202 for wireless charging, according to an example of the present subject matter. The electronic device 200 includes a rechargeable battery 204 and a first set of coils 206-1, 206-2, 206-3, and 206-4, with each coil individually coupled to the rechargeable battery 204. The first set of coils of the electronic device 200 is collectively referred to as device coils 206. The charging base 202 includes a second set of coils 208-1, 208-2, 208-3, and 208-4, collectively referred to as charging coils 208. As shown, the device coils 206 of electronic device 200 and the charging coils 208 of the charging base 202 have the same arrangement such that when the electronic device 200 is placed on the charging base 202 the device coils 206 overlap the charging coils 208. The arrangement of device coils 206 and charging coils 208 is not restricted to the example arrangement shown in FIG. 2. In an example implementation, each of the device coils 206 and charging coils 208 of 10 W.

The electronic device 200 includes a controller 210 similar to the controller 110 of the electronic device 100, as described earlier. The charging base 202 also includes a controller 210 similar to the controller of the charging base 102, as described earlier. The controllers 210 and 220 may be implemented in a number of different ways to perform various functions for the purposes of wireless charging of the electronic device 200 using the charging base 202.

The electronic device 200 may include a transceiver (not shown) to perform NFC with other devices through a region 212 of the electronic device 100 in a similar manner as that for the electronic device 100. The electronic device 200 also includes a touch-pad 214 through which a user can provide touch-based user inputs to the electronic device 200. The electronic device 200 further includes one or more temperature sensors 216. The temperature sensors 216 monitor, for example, in real-time, temperature of various regions in the electronic device 200.

The description hereinafter describes a procedure of wireless charging of the electronic device 200 using the charging base 202, in accordance with an example implementation. In an example implementation, information with regard to the coil of the electronic device 200 which is placed in the region of NFC 212 and the coil of the electronic device 200 which is placed under the touch-pad is stored in a memory (not shown) of the electronic device 200. Further, information with regard to the coil of the electronic device 200 which is present in the vicinity of the rechargeable battery 204, in the vicinity of the controller 220, or the processing unit of the electronic device 200 is stored in the memory of the electronic device 200. Such information may be stored at the time of assembling or configuring the electronic device 200. The information may include an attribute of coils, for example, the coil number.

For the purpose of wireless charging, the electronic device 200 is placed on the charging base 202. The controller 220 of the charging base 202 passes current through each of the charging coils 208 to induce electromagnetic current in the device coils 206. The controller 210 of the electronic device 200 directs the induced electromagnetic current from the device coils 206 to the rechargeable battery 204 charging the rechargeable battery 204.

In an example implementation, the controller 210 may determine a coil, from amongst the device coils 206, that is present in the region of NFC 212. The controller 210 may fetch the information stored in the electronic device 100 to determine the coil that is present in the region of NFC 212. Upon determining the coil that is present in the region of NFC 212, the controller 210 may send a coil-OFF message to the charging base 202 to disable a coil, from amongst the charging coils 208, which overlaps with the determined coil. Upon receiving the coil-OFF message, the controller 220 may disable the coil of the charging base 202 as indicated by the coil-OFF message.

With reference to FIG. 2, the controller 210 determines the coil 206-1 to be present in the region of NFC 212, and sends a coil-OFF message to disable the coil 208-1. The controller 220 accordingly disables the coil 208-1. With the coil 208-1 disabled, the rechargeable battery 204 is charged through the charging coils 208-2, 208-3, and 208-4 of the charging base 202 and the device coils 206-2, 206-3, and 206-4 the electronic device 200 without affecting the NFC that may be performed with the electronic device 200.

In an example implementation, the controller 210 may determine, in real-time, whether the transceiver is active for the NFC and accordingly send a coil-OFF message or a coil-ON message for disabling or enabling a specific coil of the charging base 202 in a similar manner as described earlier with reference to FIG. 1.

Further, in an example implementation, the controller 210 may determine a coil, from amongst the device coils 206, that is present under the touch-pad 214. The controller 110 may fetch the information stored in the electronic device 100 to determine the coil that is present under the touch-pad 214. Upon determining the coil that is present under the touch-pad 214, the controller 210 may send a coil-OFF message to the charging base 202. This coil-OFF message includes information indicative of disabling a coil, from amongst the charging coils 208, which overlaps with the determined coil of the electronic device 200. In an example implementation, the controller 220 of the charging base 202 may receive the coil-OFF message and accordingly disable the coil of the charging base 202 as indicated by the coil-OFF message.

With reference to FIG. 2, the controller 210 determines the coil 206-2 to be present under the touch-pad 214, and sends a coil-OFF message to disable the coil 208-2. The controller 220 accordingly disables the coil 208-2. With the coil 208-2 disabled, the rechargeable battery 204 is charged through other charging coils 208-1, 208-3, and 208-4 of the charging base 202 and other device coils 206-1, 206-3, and 206-4 the electronic device 200 without affecting the performance of the touch-pad 214.

In an example implementation, the controller 210 may determine, in real-time, whether the touch-pad 214 is active to receive touch-based user inputs. When the touch-pad 214 is determined to be active, the controller 210 sends the coil-OFF message to the charging base 202 to disable the coil of the charging base 202 which overlaps with the coil of the electronic device 200 present under the touch-pad 214. Further, when the touch-pad 214 is determined to be inactive, the controller 210 sends a coil-ON message to the charging base, which indicates to enable the coil of charging base 202 which overlaps with the coil of the electronic device 200 present under the touch-pad 214. In an example implementation, the controller 220 receives the coil-ON message and accordingly enables the coil of the charging base 202 as indicated by the coil-ON message. Disabling and enabling the coil of charging base 202 in real-time depending on whether the touch-pad 214 is active or inactive facilitates in efficient and effective wireless charging of the electronic device 100 without affecting the performance of the touch-pad 214.

Further, in an example implementation, the controller 210 may determine a coil, from amongst the device coils 206, that is present in a region, in the electronic device 200, at a high temperature. The high temperature being more than a specific temperature. The controller 210 may determine the coil that is present in such a region based on the information from the temperature sensors 216. The temperature sensor 216 may monitor temperature at various regions in the electronic device 200. For example, regions in the vicinity of the rechargeable battery 204, in the vicinity of the controller 220 or the processing resource of the electronic device 200, may be monitored. The controller 220 may identify the region at high temperature, and determine the coil that is present in that region based on the information of the device coils 206 stored in the electronic device 200.

Upon determining the coil that is present in the region at high temperature, the controller 210 may send a coil-OFF message to the charging base 202 to disable a coil, from amongst the charging coils 208, which overlaps with the determined coil of the electronic device 200. In an example implementation, the controller 220 of the charging base 202 may receive the coil-OFF message and accordingly disable the coil of the charging base 202 as indicated by the coil-OFF message.

With reference to FIG. 2, the temperature sensor 216 may identify the region in the vicinity of the rechargeable battery 204 to be at a temperature more than the specific temperature. The controller 210 may accordingly determine the coil 206-3 to be present in such a region, and send a coil-OFF message to disable the coil 208-3. The controller 220 may disable the coil 208-3. With the coil 208-3 disabled, the rechargeable battery 204 may be charged through other charging coils 208-1, 208-2, and 208-4 of the charging base 202 and other device coils 206-1, 206-2, and 206-4 the electronic device 200 without affecting overheating the rechargeable battery 204.

Further, in an example implementation, the controller 210 may determine whether the temperature of the aforesaid region of high temperature is below the specific temperature. Accordingly, the controller 210 may send a coil-ON message to the charging base 202 to enable the coil of the second set which overlaps with the coil of the first set present in the region of reduced temperature. The controller 220 of the charging base 202 may receive the coil-ON message and switch ON the coil of the charging base 202 as indicated by the coil-ON message.

Although the above description describes disabling or switching OFF of one of the coils of the charging base during wireless charging; in an example implementation, a combination of coils of the charging base which overlap corresponding coils of the electronic device present in the region of NFC, under the touch-pad, and in the region of high temperature, may be disabled or switched OFF.

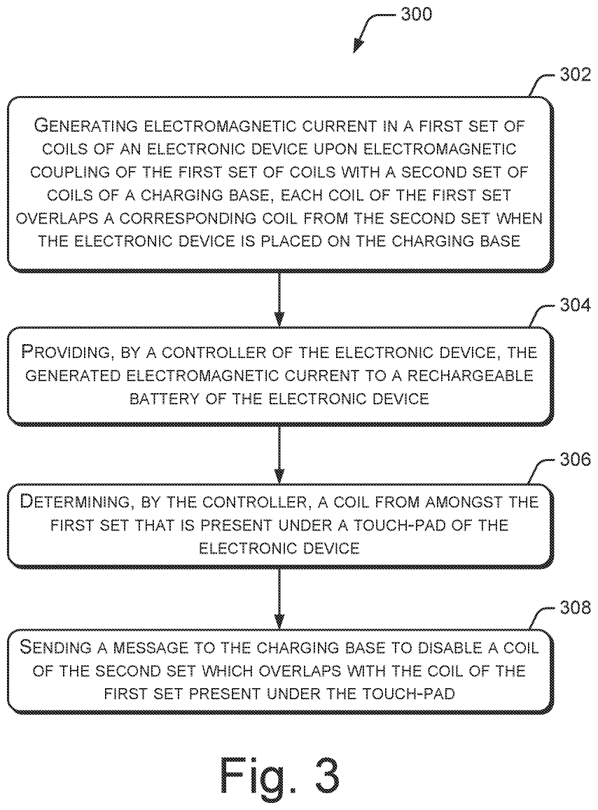

FIG. 3 illustrates a method 300 of wireless charging a rechargeable battery in an electronic device, according to an example of the present subject matter. The method 300 can be implemented by processor(s) or device(s) through any suitable hardware, a non-transitory machine readable medium, or a combination thereof. Further, although the method 300 is described in context of the aforementioned electronic device 200 and charging base 202, other suitable devices or systems may be used for execution of the method 300. In some example implementations, processes involved in the method 300 can be executed based on instructions stored in a non-transitory computer-readable medium. The non-transitory computer-readable medium may include, for example, digital memories, magnetic storage media, such as a magnetic disks and magnetic tapes, hard drives, or optically readable digital data storage media.

Referring to FIG. 3, at block 302, electromagnetic current is generated in a first set of coils of the electronic device 200 upon electromagnetic coupling of the first set of coils with a second set of coils of the charging base 202. For this, the electronic device 200 is placed on the charging base 202, and the charging base 202 is switched ON. The first set of coils and the second set of coils may be arranged in the electronic device 200 and the charging base 202, respectively, such that each coil of the first set overlaps a corresponding coil from the second set when the electronic device 200 is placed on the charging base 202. At block 304, the generated electromagnetic current is provided, by the controller 210 of the electronic device 200, to the rechargeable battery 204 of the electronic device 200. This starts charging the rechargeable battery 204.

At block 306, a coil from amongst the first set of coils that is present under a touch-pad 214 of the electronic device 200 is determined by the controller 210. In an example implementation, the coil that is present under the touch-pad 214 is determined based on the information of device coils 206 stored in the electronic device 200, as described earlier. Upon determining the coil that is present under the touch-pad 214, a message is sent by the controller 210 to the charging base 202 to disable a coil of the second set which overlaps with the coil of the first set present under the touch-pad 214, at block 308. This message is indicative of the coil of the second set which is to disabled. As described earlier, such a message is received by the controller 220 of the charging base 202 and the coil indicated by the message is switched OFF by the controller 220.

In an example implementation, whether the touch-pad 214 of the electronic device 200 is active to receive touch-based user inputs is determined by the controller 210. A message is sent by the controller 210 to the charging base 202 to disable the coil of the second set which overlaps with the coil of the first set present under the touch-pad 214, when the touch-pad 214 is determined to be active. The message is received by the controller 220 and accordingly the coil of the second set is switched OFF by the controller 220. Further, when the touch-pad is determined to be inactive, a message is sent by the controller 210 to the charging base 202 to enable the coil of the second set which overlaps with the coil of the first set present under the touch-pad. Such a message is received by the controller 220 and accordingly the coil of the second set is switched ON by the controller 220.

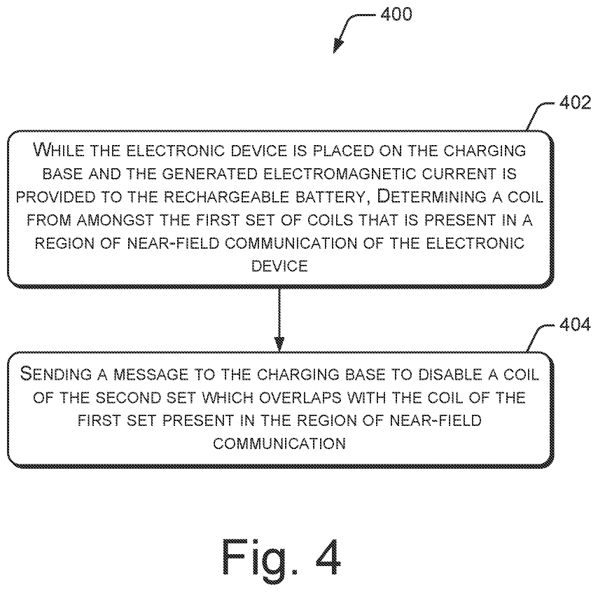

FIG. 4 illustrates a method 400 of wireless charging a rechargeable battery in an electronic device, according to an example of the present subject matter. The method 400 can be implemented by processor(s) or device(s) through any suitable hardware, a non-transitory machine readable medium, or a combination thereof. Further, although the method 400 is described in context of the aforementioned electronic device 200 and charging base 202, other suitable devices or systems may be used for execution of the method 400. In some example implementations, processes involved in the method 400 can be executed based on instructions stored in a non-transitory computer-readable medium. The non-transitory computer-readable medium may include, for example, digital memories, magnetic storage media, such as a magnetic disks and magnetic tapes, hard drives, or optically readable digital data storage media.

Referring to FIG. 4, at block 402, while the electronic device 200 is placed on the charging base 202 and the generated electromagnetic current is provided, by the controller 210, to the rechargeable battery 204, a coil from amongst the first set of coils that is present in a region of NFC 212 of the electronic device 200 is determined by the controller 210. In an example implementation, the coil that is present in the region of NFC 212 is determined based on the information of device coils 206 stored in the electronic device 200, as described earlier. Upon determining the coil that is present in the region of NFC 212, a message is sent by the controller 210 to the charging base 202 to disable a coil of the second set which overlaps with the coil of the first set present in the region of NFC 212, at block 404. This message is indicative of the coil of the second set which is to disabled. As described earlier, such a message is received by the controller 220 of the charging base 202 and the coil indicated by the message is switched OFF by the controller 220.

In an example implementation, whether a transceiver of the electronic device 200 is active for the NFC is determined by the controller 210. A message is sent by the controller 210 to the charging base 202 to disable the coil of the second set which overlaps with the coil of the first set present in the region of NFC 212, when the transceiver is determined to be active. Such a message is received by the controller 220 and accordingly the coil of the second set is switched OFF by the controller 220. Further, when the transceiver is determined to be inactive, a message is sent by the controller 210 to the charging base 202 to enable the coil of the second set which overlaps with the coil of the first set present in the region of NFC 212. Such a message is received by the controller 220 and accordingly the coil of the second set is switched ON by the controller 220.

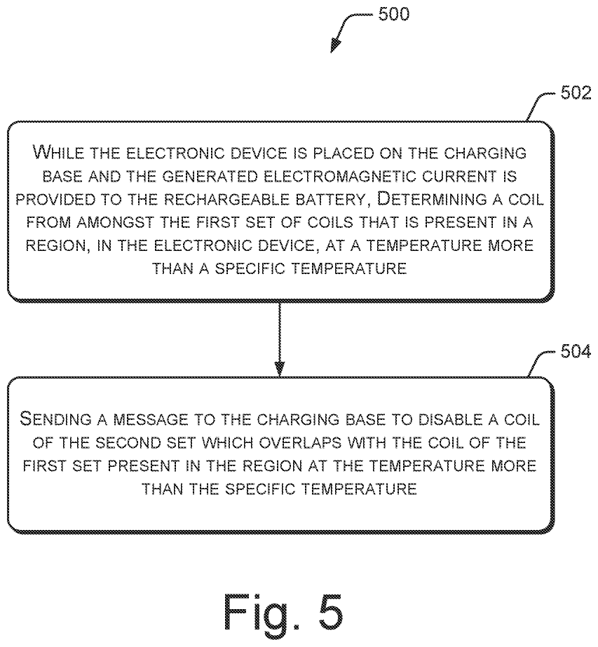

FIG. 5 illustrates a method 500 of wireless charging a rechargeable battery in an electronic device, according to an example of the present subject matter. The method 500 can be implemented by processor(s) or device(s) through any suitable hardware, a non-transitory machine readable medium, or a combination thereof. Further, although the method 500 is described in context of the aforementioned electronic device 200 and charging base 202, other suitable devices or systems may be used for execution of the method 500. In some example implementations, processes involved in the method 500 can be executed based on instructions stored in a non-transitory computer-readable medium. The non-transitory computer-readable medium may include, for example, digital memories, magnetic storage media, such as a magnetic disks and magnetic tapes, hard drives, or optically readable digital data storage media.

Referring to FIG. 5, at block 502, while the electronic device 200 is placed on the charging base 202 and the generated electromagnetic current is provided, by the controller 210, to the rechargeable battery 204, a coil from amongst the first set of coils that is present in a region, in the electronic device, at a temperature more than a specific temperature is determined by the controller 210. In an example implementation, the coil that is present in the region at the temperature more than the specific temperature is determined based on the information from temperature sensors 216 in the electronic device 200 and information of device coils 206 stored in the electronic device 200, as described earlier. Upon determining the coil that is present in the region at the temperature more than the specific temperature, a message is sent by the controller 210 to the charging base 202 to disable a coil of the second set which overlaps with the coil of the first set present in the region at the temperature more than the specific temperature, at block 504. As described earlier, such a message is received by the controller 220 of the charging base 202 and the coil indicated by the message is switched OFF by the controller 220. Further, in an example implementation, when the temperature of the aforesaid region of high temperature is determined to be below the specific temperature, a message is sent by the controller 210 to the charging base 202 to enable the coil of the second set which overlaps with the coil of the first set present in the region of reduced temperature. Such a message is received by the controller 220 of the charging base 202 and the coil indicated by the message is switched ON by the controller 220.

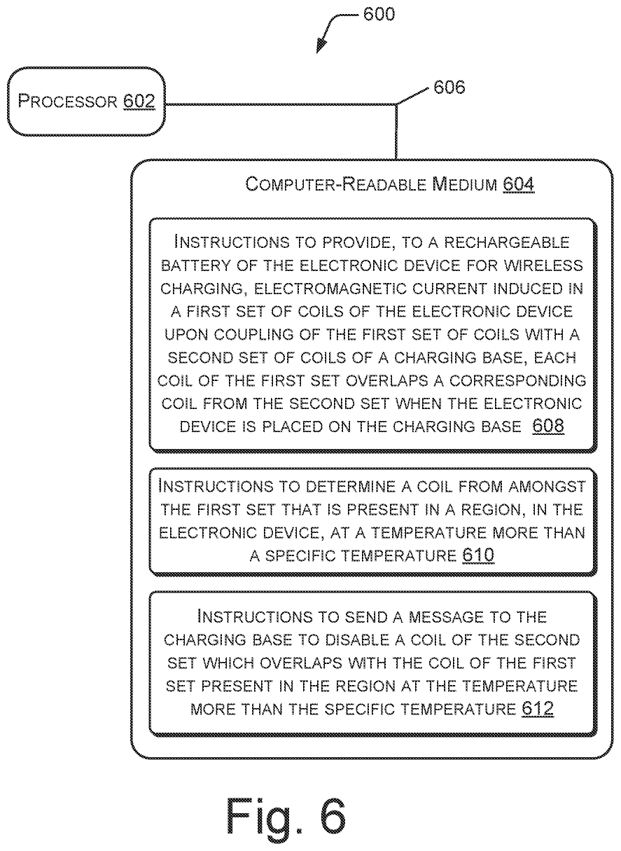

FIG. 6 illustrates a system environment 600 implementing a non-transitory computer readable medium for wireless charging, according to an example of the present subject matter. The system environment 600 includes a processor 602 communicatively coupled to the non-transitory computer-readable medium 604 through a communication link 606. In an example, the processor 602 may be a processing resource of an electronic device for fetching and executing computer-readable instructions from the non-transitory computer-readable medium 604. The electronic device may be the electronic device 200 as described with reference to FIG. 2.

The non-transitory computer-readable medium 604 can be, for example, an internal memory device or an external memory device. In an example implementation, the communication link 606 may be a direct communication link, such as any memory read/write interface. In another example implementation, the communication link 606 may be an indirect communication link, such as a network interface. In such a case, the processor 602 can access the non-transitory computer-readable medium 604 through a communication network (not shown).

In an example implementation, the non-transitory computer-readable medium 604 includes a set of computer-readable instructions for wireless charging of the electronic device 200 using a charging base 202. The set of computer-readable instructions can be accessed by the processor 602 through the communication link 606 and subsequently executed to perform acts for wireless charging of the electronic device 200 using the charging base 202. The electronic device 200 include a first set of coils and the charging base 202 includes a second set of coils, as described earlier. The electronic device 200 is placed on the charging base 202 such that the first set of coils overlap the second set of coils.

Referring to FIG. 6, in an example, the non-transitory computer-readable medium 604 may include instructions 608 to provide, to a rechargeable battery 204 of the electronic device 200 for wireless charging, electromagnetic current induced in the first set of coils of the electronic device 200 upon coupling of the first set of coils with a second set of coils of the charging base 202. As described earlier, each coil of the first set overlaps a corresponding coil from the second set when the electronic device 200 is placed on the charging base 202.

The non-transitory computer-readable medium 604 may include instructions 610 to determine a coil from amongst the first set of coils that is present in a region, in the electronic device 200, at a temperature more than a specific temperature. The non-transitory computer-readable medium 604 may include instructions 612 to send a message to the charging base 202 to disable a coil of the second set which overlaps with the coil of the first set present in the region at the temperature more than the specific temperature. The charging base 202 may accordingly disable the coil indicated by such a message.

In an example implementation, the non-transitory computer-readable medium 604 may include instructions to send a message to the charging base 202 to enable the coil of the second set once the temperature of the region in the electronic device 200 is determined to be below the specific temperature. The charging base 202 may accordingly enable the coil indicated by such a message.

Further, in an example implementation, the non-transitory computer-readable medium 604 may include instructions to determine a coil from amongst the first set of coils that is present under a touch-pad 214 of the electronic device 200. The non-transitory computer-readable medium 604 may include instructions to send a message to the charging base 202 to disable a coil of the second set which overlaps with the coil of the first set present under the touch-pad 214. The charging base 202 may accordingly disable the coil indicated by the message.

Further, in an example implementation, the non-transitory computer-readable medium 604 may include instructions to determine, in real-time, whether the touch-pad 214 is active to receive touch-based user inputs. The non-transitory computer-readable medium 604 may include instructions to send the message to the charging base 202 to disable the coil of the second set which overlaps with the coil of the first set present under the touch-pad 214, when the touch-pad 214 is determined to be active. The non-transitory computer-readable medium 604 may include instructions to send a message to the charging base 202 to enable the coil of the second set which overlaps with the coil of the first set present under the touch-pad 214, when the touch-pad 214 is determined to be inactive.

Further, in an example implementation, the non-transitory computer-readable medium 604 may include instructions to determine a coil from amongst the first set of coils that is present in a region of NFC 212 of the electronic device 200. The non-transitory computer-readable medium 604 may include instructions to send a message to the charging base 202 to disable a coil of the second set which overlaps with the coil of the first set present in the region of NFC 212. The charging base 202 may accordingly disable the coil indicated by such a message.

Further, in an example implementation, the non-transitory computer-readable medium 604 may include instructions to determine, in real-time, whether a NFC transceiver of the electronic device 200 is active for NFC. The non-transitory computer-readable medium 604 may include instructions to send the message to the charging base 202 to disable the coil of the second set which overlaps with the coil of the first set present in the region of NFC 212, when the NFC transceiver is determined to be active. The non-transitory computer-readable medium 604 may include instructions to send a message to the charging base 202 to enable the coil of the second set which overlaps with the coil of the first set present in the region of NFC, when the NFC transceiver is determined to be inactive.

Although examples for the present disclosure have been described in language specific to structural features and/or methods, it is to be understood that the appended claims are not limited to the specific features or methods described herein. Rather, the specific features and methods are disclosed and explained as examples of the present disclosure.

We claim:

1. An electronic device comprising:
a rechargeable battery;
a first set of coils coupled to the rechargeable battery, the first set of coils is to couple to a second set of coils of a second device to induce electromagnetic current in the first set of coils; and
a controller to:
determine a coil from amongst the first set of coils that adversely affects a functionality of a component of the electronic device; and
send a message to the second device to disable a coil of the second set of coils which overlaps with the coil of the first set of coils that adversely affects the functionality of the component of the electronic device.

2. The electronic device as claimed in claim 1, wherein the component is a transceiver, wherein the controller is to:
determine whether the transceiver is active; and
when the transceiver is determined to be active, send the message to the second device to disable the coil of the second set of coils which overlaps with the coil of the first set of coils that adversely affects the functionality of the transceiver component present in a region of near-field communication.

3. The electronic device as claimed in claim 1, wherein the component is a transceiver, wherein the controller is to:
determine whether the transceiver is active; and
when the transceiver is determined to be inactive, refrain from sending the message to the second device to disable the coil of the second set of coils.

4. The electronic device as claimed in claim 1, wherein the controller is to:
determine a second coil from amongst the first set of coils that adversely affects a functionality of a second component of the electronic device; and
send a second message to the second device to disable a second coil of the second set of coils which overlaps with the second coil of the first set of coils that adversely affects the functionality of the second component of the electronic device.

5. The electronic device as claimed in claim 4, wherein the component is a transceiver and the second component is a touch-pad, wherein the controller is to:
determine whether the transceiver and the touch-pad are active;
when the transceiver is determined to be active, send the message to the second device to disable a coil of the second set of coils which overlaps with a coil of the first set of coils that adversely affects the functionality of the transceiver, and
when the touch-pad is determined to be active, send the second message to the second device to disable the second coil of the second set of coils which overlaps with the second coil of the first set of coils that adversely affect the functionality of the touch-pad.

6. The electronic device as claimed in claim 4, wherein the component is a transceiver and the second component is a touch-pad, wherein the controller is to:
determine whether the transceiver and the touch-pad are active;
when the transceiver is determined to be inactive, refrain from sending the message to the second device to disable the coil of the second set of coils; and
when the touch-pad is determined to be inactive, refrain from sending the second message to the second device to disable the second coil of the second set of coils.

7. A method of wireless charging a rechargeable battery in an electronic device, the method comprising:
generating electromagnetic current in a first set of coils coupled to the rechargeable battery of the electronic device upon electromagnetic coupling of the first set of coils with a second set of coils of a second device, each coil of the first set overlaps a corresponding coil from the second set when the electronic device contacts the second device;
determining, by a controller, if a coil of the first set of coils electromagnetically coupled to a coil of the second set of coils adversely affects a functionality of a component in the electronic device; and
sending a message to the second device to disable the coil of the second set of coils which overlaps with the coil of the first set of coils adversely affecting the functionality of the component in the electronic device.

8. The method as claimed in claim 7, comprising:
determining whether the component is active;
sending the message to the second device to disable the coil of the second set of coils which overlaps with the coil of the first set of coils adversely affecting the functionality of the component, responsive to a determination that the component is active; and
sending a message to the second device to enable the coil of the second set of coils which overlaps with the coil of the first set of coils adversely affecting the functionality of the component in the electronic device, responsive to a determination that the component is inactive.

9. The method as claimed in claim 7, comprising:
determining each component of a plurality of components that is adversely affected by the wireless charging of the rechargeable battery; and
identify each coil of the first set of coil associated with each component adversely affected by the wireless charging of the rechargeable battery, subsequent to determining each component adversely affected by the wireless charging of the rechargeable battery.

10. The method as claimed in claim 7, wherein determining if a coil of the first set of coils adversely affects a functionality of a component in the electronic device comprises, determining a temperature of a region including a processor component is more than a specific temperature.

11. The method as claimed in claim 7, comprising sending the message to the second device to disable the coil of the second set of coils which overlaps with the coil of the first set of coils adversely affecting the functionality of the processor component.

12. A non-transitory computer-readable medium comprising computer-readable instructions, which, when executed by a processor of an electronic device, cause the processor to:
provide, to a rechargeable battery of the electronic device, electromagnetic current induced in a first set of coils of the electronic device upon coupling of the first set of coils with a second set of coils of a second device, each coil of the first set overlaps a corresponding coil from the second set when the electronic device contacts the second device;
determine if a coil of the first set of coils adversely affects a functionality of a component in the electronic device; and
send a message to the second device to disable a coil of the second set of coils corresponding to the coil of the first set of coils that adversely affects the functionality of the component in the electronic device.

13. The non-transitory computer-readable medium as claimed in claim 12, wherein the instructions which, when executed by the processor, cause the processor to determine if the coil of the first set of coils causes a region including a processor to have a temperature more than a specific temperature to determine if the coil of the first set of coils adversely affects the functionality of the processor.

14. The non-transitory computer-readable medium as claimed in claim 13, wherein the instructions which, when executed by the processor, cause the processor to send the message to the second device to disable the coil of the second set of coils corresponding to the coil of the first set of coils, responsive to the determination that the coil of the first set of coils causes the region including a processor to have the temperature more than the specific temperature.

15. The non-transitory computer-readable medium as claimed in claim 13, wherein the instructions which, when executed by the processor, cause the processor to refrain from sending the message to the second device to disable the coil of the second set of coils corresponding to the coil of the first set of coils, responsive to the determination that the coil of the first set of coils causes the region including a processor to have the temperature less than or at the specific temperature.
